(19) United States
(12) Patent Application Publication
(10) Pub. No.: US 2026/0252555 A1
(43) Pub. Date: Aug. 27, 2026

(54) Computer System, Computer-Implemented Method, and Computer Readable Media for Managing Query Responses

(71) Applicant: Shopify Inc., Ottawa (CA)

(72) Inventors: Tyler ROWSELL, Ottawa (CA); Matthew David KOENIG, Bellevue, WA (US); Jesse McGINNIS, Waterloo (CA); Agatha KRAJEWSKI, Manotick (CA)

(73) Assignee: Shopify Inc., Ottawa (CA)

(21) Appl. No.: 19/179,299

(22) Filed: Apr. 15, 2025

Related U.S. Application Data
(60) Provisional application No. 63/763,525, filed on Feb. 26, 2025.

(51) Int. Cl. G06F 16/242

(52) U.S. Cl. CPC G06F 16/2425

(57) ABSTRACT

A system and method are provided for responding to unmatched queries. The method includes determining that a query compared to a knowledge store of query and response pairs is unmatched, adding the query to a collection of unmatched queries, using the collection of unmatched queries to identify a group of aggregated unmatched queries, determining a representative query for the group of aggregated unmatched queries, and using the representative query to obtain a response to the representative query.

### CROSS-REFERENCE TO RELATED APPLICATIONS

This application claims priority to U.S. Provisional Application No. 63/763,525 filed on February 26, 2025, the entire contents of which are incorporated herein by reference.

### TECHNICAL FIELD

The following relates generally to managing responses to queries and, in particular, to handling responses to unmatched queries.

### BACKGROUND

Users may interact with an entity to obtain answers to questions they submit to that entity. This may include using a large language model (LLM)-powered chatbot in a third party service that communicates with an enterprise platform and/or with a search engine or other third party resource to obtain the answer(s). Such users may pose follow-up questions about the answers they receive. When using an LLM-powered chatbot, for example, the chatbot may lack real-time access to updated or domain-specific information (e.g., policies, technical details, etc.), necessitating external data sourcing.

### BRIEF DESCRIPTION OF THE DRAWINGS

Embodiments will now be described with reference to the appended drawings wherein:

FIG. 1 is an example of a computing environment in which inputs are evaluated prior to prompting an LLM.

FIG. 2a is an example of a configuration for communicating with a query engine.

FIG. 2b is an example of another configuration for communicating with a query engine.

FIG. 3 is an example of a configuration for implementing the query engine.

FIG. 4 is an example of a computing device operable to be utilized in the computing environment.

FIG. 5 is a sequence diagram illustrating a process for responding to unmatched queries based on a confidence value.

FIG. 6 is a sequence diagram illustrating a process for aggregating unmatched queries to determine a response to such queries.

FIG. 7 illustrates an example of a query and a response.

FIG. 8 illustrates an example of a knowledge store user interface (UI).

FIG. 9 illustrates an example of a question answer (QA) pair generated by an LLM and presented in a UI for verification.

FIG. 10 illustrates an example of a QA pair creation UI.

FIG. 11 is a flow chart illustrating example operations for responding to an unmatched query based on a confidence value.

FIG. 12 is a flow chart illustrating example operations for generating different responses to an unmatched query according to a determined confidence value.

FIG. 13 is a flow chart illustrating example operations for obtaining a verified response to an unmatched query.

FIG. 14 is a flow chart illustrating example operations for aggregating similar unmatched queries to determine a response.

FIG. 15 is a flow chart illustrating example operations for having a new query and response pair verified.

FIG. 16 illustrates an example of an electronic messaging conversation UI.

FIGS. 17a, 17b, and 17c illustrate examples of different responses to queries generated based on a query provided in the UI shown in FIG. 16.

FIG. 18 is a block diagram of a simplified convolutional neural network, which may be used in examples of the present disclosure.

FIG. 19 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Challenges in processing user requests for information may arise due to various factors. For example, required information may reside outside of the search result’s uniform resource locator (URL) (e.g., store policies not on the product page, etc.), sometimes requiring extensive web scraping. Moreover, indiscriminate scraping or processing of large text corpora may consume excessive computational resources, which can lead to delaying responses and degrading the user experience. Furthermore, real-time query processing may incur high compute costs, even with caching. Repeated cache misses may exacerbate latency and further strain resources.

Current QA or query systems may prioritize immediate responses but struggle to balance accuracy with computational efficiency, particularly for new or aggregated queries lacking pre-cached or otherwise pre-stored answers. Industry demands for low-latency, cost-effective solutions highlight the need for adaptive methods to manage dynamic user interactions without overloading infrastructure. That is, current QA or query systems may be faced with challenges relating to high latency and potentially excessive computational costs in responding to dynamic user queries on search results.

To address these challenges, the system described in the present disclosure may store a number of matching QA pairs to respond to queries. Successful matches may be returned to the user. Unsuccessful matches may be dealt with using either or both: i) a confidence-based differential response, and ii) asynchronous aggregation and processing of unmatched queries.

The system may include processes that are used with, or support, a query matching system. The query matching system may include a knowledge store or QA-pair data set. The knowledge store may, additionally or alternatively, be considered a knowledge base, set of QA pairs or “pool” of QA pairs that may evolve over time. There may be a mechanism to pre-load the knowledge store, which may additionally be used at other points in time either automatically or manually. For example, the knowledge store may be populated with QA pairs that are generated using an LLM, either automatically or semi-automatically, or manually by an administrator.

The query matching system may provide an interface to receive inputs. These inputs may be provided directly by a user or indirectly by a service or tool utilized by the user, e.g., an LLM-powered chatbot that communicates with a platform that hosts the query matching system. The inputs may include a question that is parsed from the content of a message or otherwise processed to determine if a matching QA pair can be found. The processing of the content of the input may itself utilize an LLM. For example, the query/response may utilize an ability to convert or translate or otherwise interpret query language, e.g., to detect that “accept returns” relates to a stored question “how do I make a return” in order to determine that a match has occurred. The match may be associated with a confidence level applied to the match. A threshold may be used to determine if a response should be returned, e.g., that there is a high enough confidence that a particular QA pair matches the request. The threshold value may be defined, selected, and updated or changed.

The knowledge store may include a knowledge base or pool of QA pairs that may be customized automatically (e.g., by an LLM)) or reactively or on-demand by an administrator. The administrator may have a worker thread or worker process monitor the knowledge store of QA pairs to refine or verify answers and/or to adapt to new sources of information or changes to associated content. This may be done asynchronously or periodically, e.g., as a batch-processed operation. The QA pairs may therefore be tied to certain data sources such that updates can propagate back to the knowledge store – e.g., changes to store hours, modified return policies, temporal campaigns or sales, etc.

When the query matching system receives a request for matching a query to a QA pair, e.g., by receiving a question posed in a message, the system may check the knowledge store for a match. The message may be provided using, for example, a chat message or other messaging medium, or accessed/provided via a computer interface such as an application programming interface (API). This may be done using, for example, an LLM-based semantic analysis, or a vector similarity search. When a QA pair match is found or the system is confident that a certain QA pair provides the appropriate information, the answer may be returned to the entity that made the request, e.g., user, LLM-powered chatbot, client application, etc. When a request is unmatched, the query matching system may execute one or both of the following processes, namely a confidence-based differential response and asynchronous aggregation processing.

When a query is unmatched based on the current contents of the knowledge store of QA pairs, a confidence-based differential response may attempt to obtain an answer to a question posed in the request.

The entity providing the query may be notified that the query matching system is attempting to obtain an answer, e.g., by providing a standard reply, or by displaying a progress or waiting indicator. The query matching system may then utilize an LLM to conduct a secondary search and obtain an answer to the posed question.

A confidence score may be computed based on the amount, consistency or quality of the content that the LLM can find; the availability of sources; the ability to verify a source; etc. Any suitable confidence measurement process may be utilized. The confidence score may be compared to a threshold or one or more ranges of values to determine which differential response tier or range to use. For example, above a certain upper threshold, the query matching system may be confident in returning the LLM-generated answer directly to the user. On the other hand, below a certain lower threshold, the query matching system may determine that there is a low confidence in the answer and that either an answer cannot be found, or an escalation is required. For example, the user may be notified that the system needs more time to find the answer and an administrator may be contacted to verify, edit or provide the answer. The system may then enter the user into an asynchronous response queue and notify the user that they will receive a response to their query at a later point e.g., via an email, inbox message or other medium that is not a real-time conversational chat context.

A UI may be presented to the administrator, along with the information and references found by the LLM. Having the administrator review the UI and verify, edit or supplement the information may enable the system to create a new QA pair for the knowledge store while triggering a follow-up message to the user, e.g., via the chat session or another channel such as an email or in their own application via an API.

One or more medium or mid-levels, tiers or ranges of confidence may be associated with other differential response tiers. For example, confidence scores between the upper and lower thresholds may have the query matching system return a qualified answer so as to not suggest it is necessarily correct. Additionally or alternatively, resources found by the LLM may be provided to the user in that response tier to have them come to their own conclusion. Multiple mid-tiers or ranges of confidence may have different associated responses. For example, a mid-to-high tier may cause the LLM to return resources to the user while a mid-to-low tier may ask the user to wait for a verified response escalated to an administrator. As such, any number of response tiers or ranges and selected actions can be mapped to each other depending on the application.

In one aspect, there is provided computer-implemented method comprising determining that a query compared to a knowledge store of query and response pairs is unmatched, determining a candidate response to the query, determining a confidence value associated with the candidate response, and responding to the query based on how the confidence value compares to a threshold value.

In certain example embodiments, responding to the query comprises determining that the confidence value is above the threshold value, and responding to the query by providing the candidate response.

In certain example embodiments, responding to the query comprises determining that the confidence value is below the threshold value, and responding to the query with an alternative to the candidate response.

In certain example embodiments, the alternative to the candidate response includes content obtained from a search used to generate the candidate response, to enable self-resolution of the query.

In certain example embodiments, the alternative to the candidate response includes an indication that a response to the query is being obtained.

In certain example embodiments, obtaining the response to the query includes providing the query to an administrator portal, and receiving an input defining a verified response.

In certain example embodiments, the method further includes following up with the verified response.

In certain example embodiments, the method further includes providing the proposed response and the query to the administrator portal.

In certain example embodiments, responding to the query comprises one of the following: responsive to determining that the confidence value is above the threshold value, responding to the query by providing the candidate response; responsive to determining that the confidence value is below a second threshold value, responding to the query with an indication that a response is unavailable; or responsive to determining that the confidence value is between the threshold value and the second threshold value, responding to the query with an alternative to the candidate response.

In certain example embodiments, the candidate response includes an answer to a question included in the query.

In certain example embodiments, the candidate response is determined using an LLM.

In certain example embodiments, the query is compared to the knowledge store using an LLM-based semantic analysis.

In certain example embodiments, the query is compared to the knowledge store using a vector similarity search.

In certain example embodiments, the query is obtained from an LLM-powered chatbot.

In certain example embodiments, the method further includes providing the query to an administrator interface to have a new query and response pair generated for the knowledge store.

In another aspect, there is provided a computer system comprising: a processor; and a memory, the memory storing processor executable instructions that, when executed by the processor, cause the computer system to: determine that a query compared to a knowledge store of query and response pairs is unmatched; determine a candidate response to the query; determine a confidence value associated with the candidate response; and respond to the query based on how the confidence value compares to a threshold value.

In certain example embodiments, responding to the query comprises determining that the confidence value is above the threshold value, and responding to the query by providing the candidate response.

In certain example embodiments, responding to the query comprises determining that the confidence value is below the threshold value, and responding to the query with an alternative to the candidate response.

In certain example embodiments, the alternative to the candidate response includes content obtained from a search used to generate the candidate response, to enable self-resolution of the query.

In another aspect, there is provided a computer-readable medium storing processor executable instructions that, when executed by a processor of a computer system, cause the computer system to: determine that a query compared to a knowledge store of query and response pairs is unmatched; determine a candidate response to the query; determine a confidence value associated with the candidate response; and respond to the query based on how the confidence value compares to a threshold value.

Unmatched queries may, additionally or alternatively, be saved and aggregated with other similar queries over a period of time and/or based on a query volume, to trigger an asynchronous secondary search. The unmatched queries may be grouped together using a static embeddings model or by using an LLM to identify similar questions.

A new single question may be generated or one of the questions in the group may be used to generate an answer. The LLM, or a different LLM, may be used to generate a proposed answer to the question. The proposed answer may then be presented to an administrator to have a new QA pair generated and stored in the knowledge store for future queries. The query matching system may keep track of associated unmatched queries and/or their authors to trigger a follow-up response once an aggregated query leads to the generation of a new QA pair. This may be triggered by a period of time elapsing since the unmatched query occurred or upon storing the new QA pair in the knowledge store.

A UI may be provided for enabling an administrator to create a new QA pair. This UI may be presented in the asynchronous aggregation process. Additionally, this UI may be available to the administrator at any time, e.g., to pre-load the knowledge store as discussed above.

Unmatched queries may thus be used either synchronously or asynchronously to expand, improve and evolve the QA knowledge store over time while attempting to be responsive to the user’s request to the extent possible. The query matching system may also provide flexibility to administrators to both pre-load and continuously improve and expand the number of QA pairs in the knowledge store as the query matching system is used.

In one aspect, there is provided a computer-implemented method comprising, determining that a query compared to a knowledge store of query and response pairs is unmatched; adding the query to a collection of unmatched queries; using the collection of unmatched queries to identify a group of aggregated unmatched queries; determining a representative query for the group of aggregated unmatched queries; and using the representative query to obtain a response to the representative query.

In certain example embodiments, the method further includes using the response to the representative query to generate a new query and response pair for the knowledge store.

In certain example embodiments, the method includes providing the new query and response pair to an administrator portal; and receiving a verification of the response to the representative query.

In certain example embodiments, the method further includes providing the response to the representative query to a source of the query.

In certain example embodiments, the group of aggregated unmatched queries is determined based on a number of unmatched queries added to the collection.

In certain example embodiments, the group of aggregated unmatched queries is determined based on a time window relative to receipt of the query that is determined to be unmatched.

In certain example embodiments, the aggregated unmatched queries are grouped using an LLM.

In certain example embodiments, the aggregated unmatched queries are grouped using a static embeddings model.

In certain example embodiments, the representative query is determined by selecting a query from the group of aggregated unmatched queries.

In certain example embodiments, the representative query is determined by generating a new query based on the group of aggregated unmatched queries.

In certain example embodiments, the new query is generated using an LLM.

In certain example embodiments, the query is compared to the knowledge store using an LLM-based semantic analysis.

In certain example embodiments, the query is compared to the knowledge store using a vector similarity search.

In certain example embodiments, the query is obtained from an LLM-powered chatbot.

In certain example embodiments, the method further includes providing the query and/or the response to an administrator interface to have a new query and response pair generated for the knowledge store.

In another aspect, there is provided a computer system comprising: a processor; and a memory, the memory storing processor executable instructions that, when executed by the processor, cause the computer system to: determine that a query compared to a knowledge store of query and response pairs is unmatched; add the query to a collection of unmatched queries; use the collection of unmatched queries to identify a group of aggregated unmatched queries; determine a representative query for the group of aggregated unmatched queries; and use the representative query to obtain a response to the representative query.

In certain example embodiments, the system includes instructions that, when executed by the processor, cause the computer system to use the response to the representative query to generate a new query and response pair for the knowledge store.

In certain example embodiments, the system includes instructions that, when executed by the processor, cause the computer system to: provide the new query and response pair to an administrator portal; and receive a verification of the response to the representative query.

In certain example embodiments, the system includes instructions that, when executed by the processor, cause the computer system to provide the response to the representative query to a source of the query.

In another aspect, there is provided a computer-readable medium storing processor executable instructions that, when executed by a processor of a computer system, cause the computer system to: determine that a query compared to a knowledge store of query and response pairs is unmatched; add the query to a collection of unmatched queries; use the collection of unmatched queries to identify a group of aggregated unmatched queries; determine a representative query for the group of aggregated unmatched queries; and use the representative query to obtain a response to the representative query.

### Query Response Management

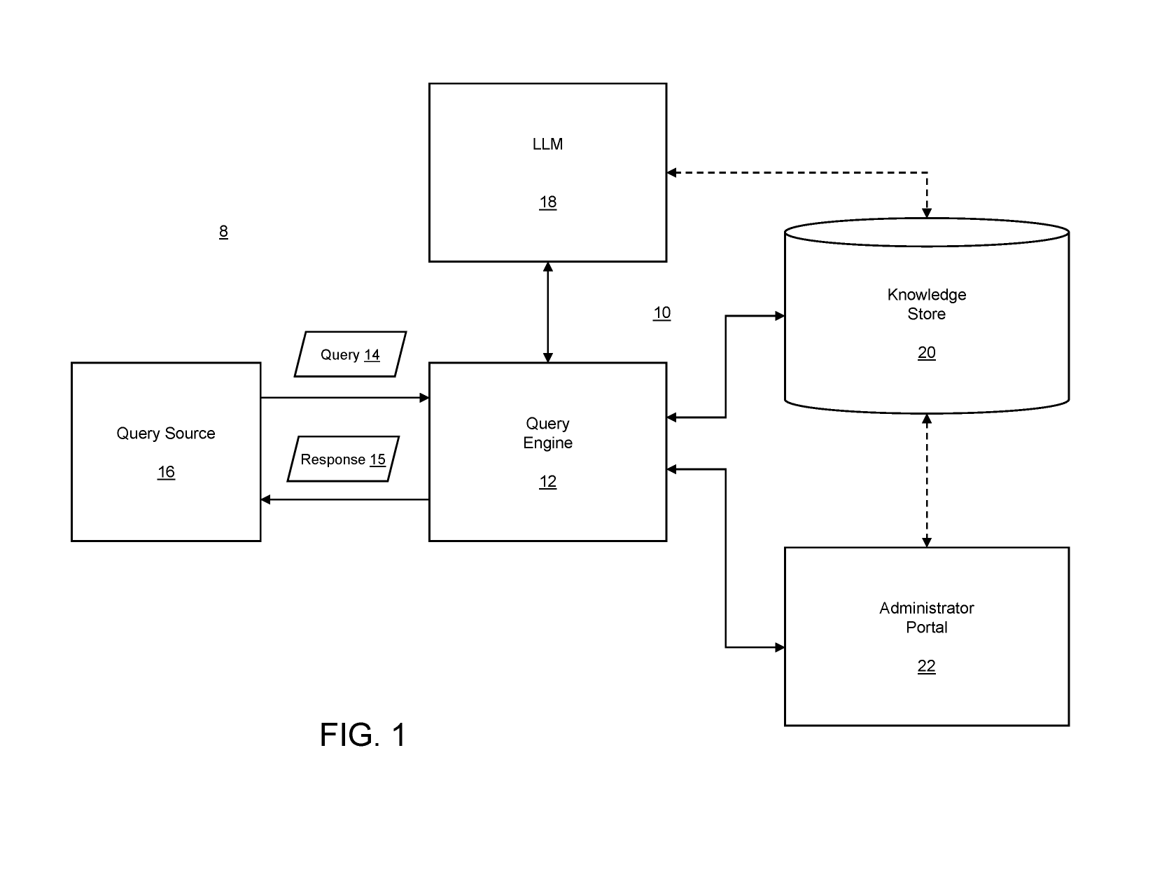

Referring now to the figures, FIG. 1 illustrates an example of a computing environment 8 in which a query management system 10 (also referred to herein as the “system 10” for brevity) provides a query engine 12 to manage queries 14 obtained by the system 10 from a query source 16. The query engine 12 processes a query 14 to generate a response 15. The query 14 may also be referred to, or be considered, a request or message or other communication that is meant to obtain a response 15. A single query source 16 is shown in FIG. 1 for illustrative purposes and it can be appreciated that several query sources 16 may utilize the query engine 12 shown or one of multiple query engines 12 (not shown).

The system 10 in this example may also include or have access to an LLM 18. The LLM 18 may be used by the query engine 12 to process queries 14 and/or to generate responses 15 to such queries 14. The query engine 12 may have access to a knowledge store 20. The knowledge store 20 may be embodied as a database, memory store or other storage unit capable of storing QA pairs, unmatched queries, and other data and information related to a query or a QA pair. For example, a QA pair may include metadata enabling the query engine 18 or the LLM 18 to determine similar or equivalent query content. For example, a query 14 referring to “closing hours” may be associated with “store hours”, “open hours”, or other equivalent references to the hours in which an establishment is open for business.

The system 10 in this example also includes or provides access to an administrator portal 22. The administrator portal 22 provides an entity to which the query engine 12 may turn to verify or provide a response 15 to a query 14 that is not matched to a QA pair in the knowledge store 20 in certain circumstances as discussed herein. The administrator portal 22 may provide an automated computing entity, a UI for manual verification or submission by an administrator, or both. The administrator portal 22 may be used by the query engine 12 to obtain additional information or to verify information generated by the LLM 18 or some other source, including the query engine 22 itself. As shown in FIG. 1, the knowledge store 20 may be accessible to the query engine 12 but optionally accessible directly by the LLM 18 and/or the administrator portal 22. In this way, the query engine 12 as well as other components of the system 10 may be used to add, edit, remove or otherwise modify the knowledge store 20 in various processes discussed herein. That is, the management of the knowledge store 20 may be controlled by the query engine 12 or by the query engine 12 and one or more other entities depending on the application, the computing environment 8 or other constraints, regulations, permissions or controls imparted on the system 10.

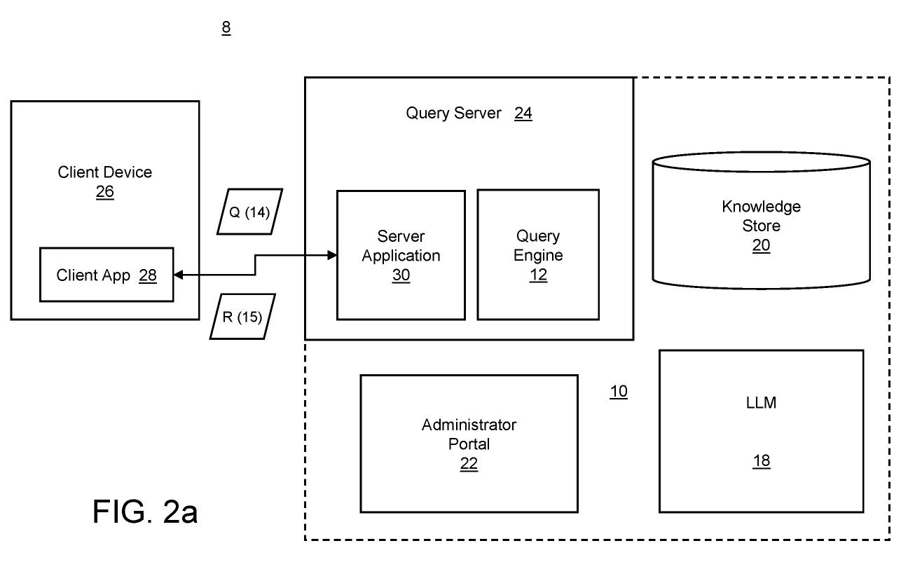

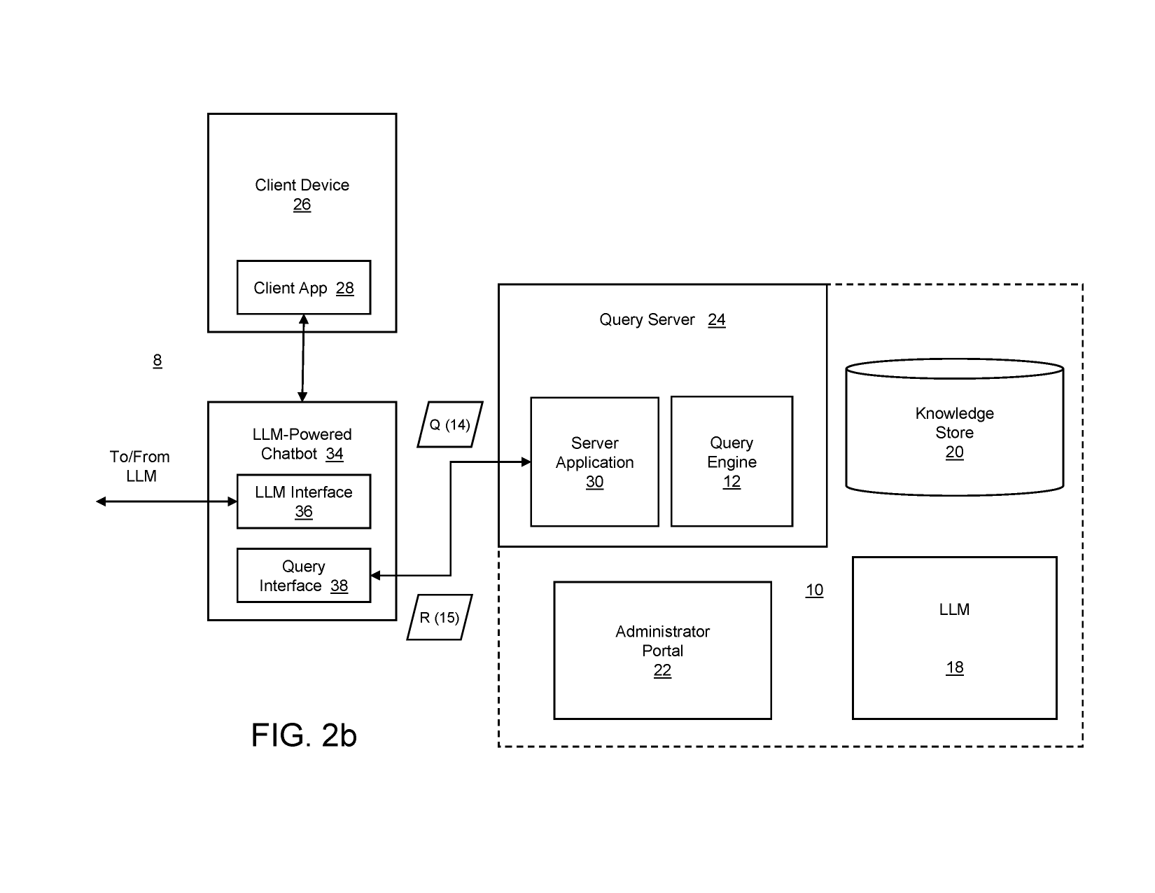

The system 10 shown in FIG. 1 may be implemented and deployed in various configurations, for example, as shown in FIGS. 2a and 2b.

Referring first to FIG. 2a, the system 10 may, in this example, provide a platform, e.g., an enterprise platform or other type software as a service (SaaS) platform (e.g., e-commerce platform) hosting a query server 24. The query server 24 may communicate with one or more client devices 26 in the computing environment 8. The client device 26 and query server 24 may be provided by or with one or more computing devices as discussed further below. Such computing devices (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

The query server 24 and the other components of the system 10 may be accessed by the client device 26 and other computing entities in the computing environment over a communication network (not shown). Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The query server 24 in this example configuration includes a server application 30 and the query engine 12. While shown separately in FIG. 2a, the query engine 12 may, in other configurations, be included as a component of the server application 30. The server application 30 may communicate with a client application 28 running on the client device 26. For example, the client device 26 may include a mobile application or “app” that embodies the client application 28. In this example, the client application 28 is configured to enable users to generate and send queries 14 to the server application 30 to obtain responses 15 to such queries 14. The server application 30 may utilize the query engine 12 to process the queries 14 and generate the responses 15. The system 10 includes or provides access to the knowledge store 20, the administrator portal 22 and the LLM 18 as a platform. It can be appreciated that the LLM 18 is shown as part of the platform embodying the system 10 for illustrative purposes and may instead be provided by a separate entity. Alternatively, multiple LLMs 18 may be utilized by the system 10, including one or more LLMs 18 hosted by/on the platform or system 10 and one or more LLMs 18 hosted by/on a separate platform, service or entity. As such, any reference herein to an LLM 18 may refer to a system-based LLM 18, a third party LLM 18 or any other available LLM 18.

FIG. 2b illustrates another configuration for the computing environment 8, in which the system 10 may be deployed in a similar fashion to that shown in FIG. 2a, but in this example the server application 30 communicates with another service such as an LLM-powered chatbot 34, e.g. Perplexity™, ChatGPT™, etc., that is being utilized by the client device 26 and, where applicable, a client application 28. The LLM-powered chatbot 34 may include an LLM interface 36 to communicate with an LLM 18 (not shown in FIG. 2b) that is used by the chatbot 34 to perform actions and processes for the user of the client device 26. The LLM-powered chatbot 34 may also have a query interface 38, such as an API to the server application 30 to enable the chatbot 34 to access and utilize the query engine 12, e.g., to leverage QA pairs stored in the knowledge store 20. As such, the query engine 12 of the system 10 may be made available to various entities in a particular computing environment 8 to provide responses 15 to queries 14, e.g., on behalf of an organization for which information is routinely or periodically sought by users of that organization, e.g., technical services, e-commerce, or other service providers.

With respect to the LLM 18 and/or LLM-powered chatbot 34, examples of generative models that may be used include, for example, OpenAI’s Generative Pre-trained Transformer family (GPT 3.5, GPT 4, ChatGPT), Meta’s Llama and Llama 2, CohereAI’s Command, Mistral/Mixtral, Anthropic’s Claude, Google’s Gemini, Gemma and Bard. These general purpose and chat-focused models may be used as both the first and second model. It can be appreciated that, in addition, more specialized models may be used as the first or second model. For example, if the error in the first model is related to code generation then a generative model specializing in code generation may be used as the second model - the Code Llama, HuggingFace’s CodeGen, Github Copilot’s Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements. The LLM 18 and/or LLM-powered chatbot 34 may, additionally or alternatively, use a fine-tuned model, e.g., by fine tuning a Llama model or other baseline model.

It can be appreciated that although transformer-based language models are described herein, the present disclosure may be applicable to any ML-based language model, including language models based on other neural network architectures such as RNN-based language models. Indeed, the consideration of an LLM 18 and/or LLM-powered chatbot 34 above are by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 18 in it, may be employed in association with the techniques discussed in the present disclosure.

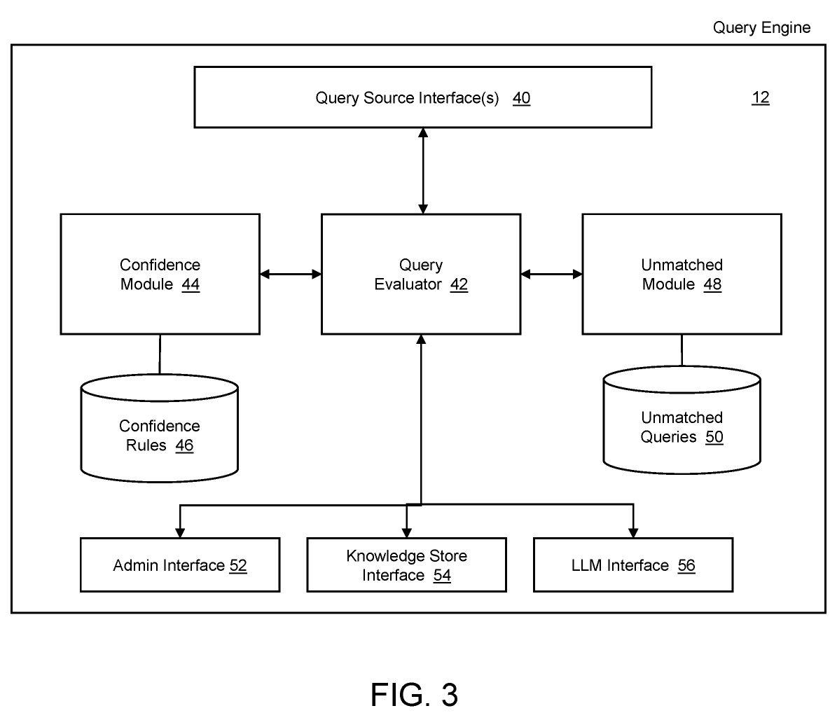

A configuration for the query engine 12 is shown in FIG. 3. The query engine 12 may include one or more query source interfaces 40 to allow various query sources 16 and types of query sources 16 (e.g., client device 26 and/or chatbot 34 – see also FIG. 1) to provide requests or pose questions via a query (Q) 14 and obtain a response (R) 15 to that query 14. The query engine 12 may include a query evaluator 42 to determine if a query 14 can be matched, that is, has a corresponding QA pair in the knowledge store 20. The query evaluator 42 may additionally utilize one or more additional features to handle unmatched queries 50, namely a confidence module 44 and an unmatched module 48. The confidence module 44 may be used by the query evaluator 42 to determine how confident the query engine 12 is in the accuracy or quality of an attempted or candidate response 15 to a query 14 that is not immediately matched to a QA pair in the knowledge store 20. The confidence module 44 may include or have access to a set of confidence rules 46, which may be customized or standard sets of confidence metrics or confidence-related parameters that allow the confidence module 44 to determine a confidence value or score.

The unmatched module 48 may be used to manage queries 14 that are not matched to QA pairs in the knowledge store 20, e.g., by aggregating similar unmatched queries in a datastore storing such unmatched queries 50. The query evaluator 42 may include additional interfaces to other components of the system 10, for example, an admin interface 52 (e.g., API or other software interface) to communicate with the admin portal 22, a knowledge store interface 54 to access the knowledge store 20, and an LLM interface 56 to access one or more LLMs 18.

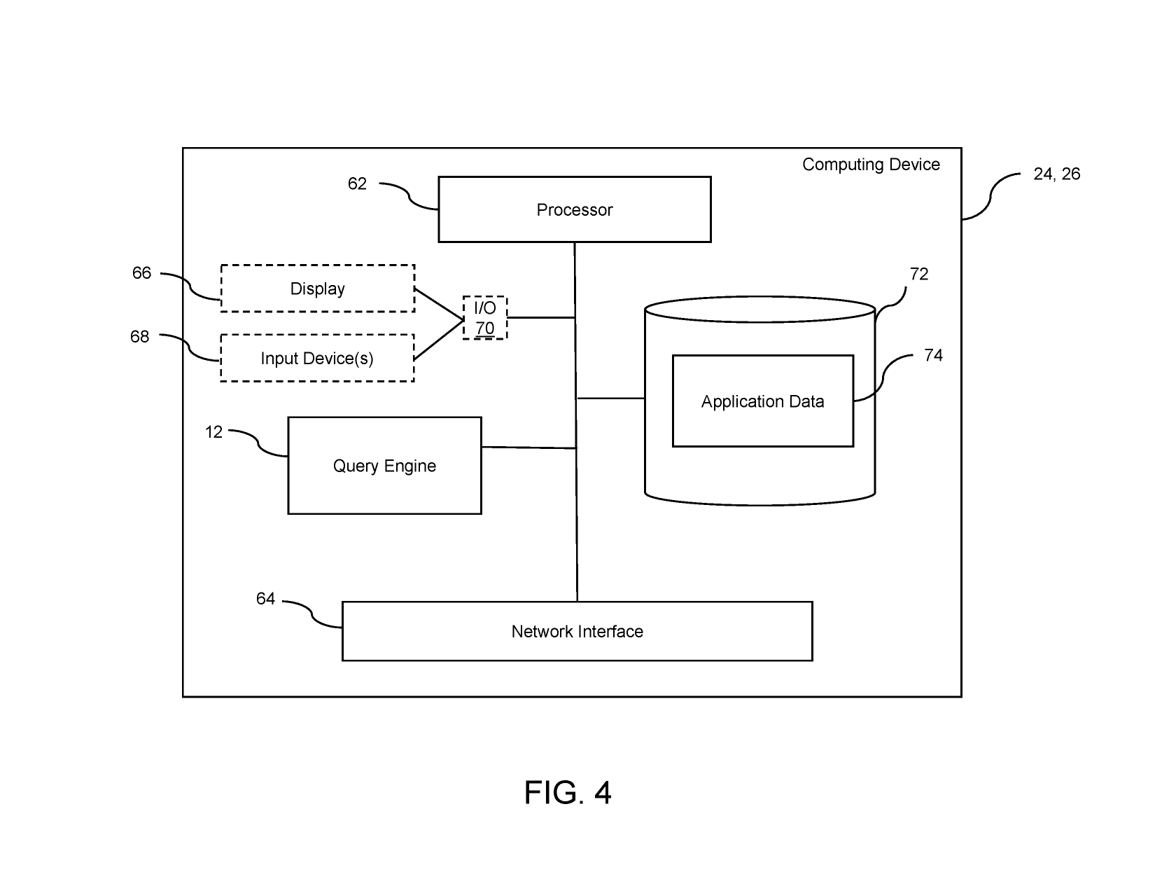

FIG. 4 shows an example of a computing device (e.g., a client device 26 or query server 24) which may be utilized by any one or more of the entities shown in FIGS. 1-3, for example, a personal electronic device or server used to provide the client application 28, chatbot 34, server application 30, query engine 12, etc. The computing device 24, 26 in FIG. 4 may, additionally or alternatively, provide an example of a computing entity or system on which the LLM 18 may be deployed or accessed.

In this example, the computing device 24, 26 includes one or more processors 62 (e.g., a microprocessor, microcontroller, embedded processor, digital signal processor (DSP), central processing unit (CPU), media processor, graphics processing unit (GPU) or other hardware-based processing units) and one or more network interfaces 64 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 24, 26 may also include the query engine 12, a data store 72, and application data 74. The query engine 12 may therefore be provided on either or both the client side or the server side and is shown in FIG. 4 for illustrative purposes. Although not shown in FIG. 4, when configured as a client device 26, the computing device or computing system may additionally include the client application 28. Similarly, when configured as a query server 24, the computing device or computing system may include the server application 30. The computing device 24, 26 may, additionally, include or otherwise have access to the knowledge store 20, which in the example shown in FIG. 4 be included in the data store 72.

The data store 72 may represent a database or library or other computer-readable medium configured to store data and permit retrieval of data by the computing device 24, 26. The data store 72 may be read-only or may permit modifications to the data. The data store 72 may also store both read-only and write accessible data in the same memory allocation. In this example, the data store 72 stores the application data 74 for an application and/or data for the client application 28, server application 30, and/or query engine 12 that is configured to be executed by the computing device 24, 26 for a particular role or purpose.

While not delineated in FIG. 4, the computing device 24, 26 includes at least one memory or memory device that can include a tangible and non-transitory computer-readable medium having stored therein computer programs, sets of instructions, code, or data to be executed by processor(s) 62. The processor(s) 62 and network interface(s) 64 are connected to each other via a data bus or other communication backbone to enable components of the computing device 24, 26 to operate together as described herein. FIG. 4 illustrates examples of modules and applications stored in memory on the computing device 24, 26 and executed by the processor(s) 62.

It can be appreciated that any of the modules and applications shown in FIG. 4 may be hosted externally and may be available to the computing device 24, 26, e.g., via the network interface 64. The data store 72 in this example stores, among other things, the application data 74 that can be accessed and utilized by an application. The data store 72 may additionally store one or more software functions or routines in a cache or in other types of memory.

As shown in FIG. 4, the computing device 24, 26 may, optionally (e.g., when configured as a personal electronic device such as a smartphone or tablet), include a display 66 and one or more input device(s) 68 that may be utilized via an input/output (I/O) module 70. That is, such components may be omitted when the computing device 24, 26 does not interact with a user.

While examples referred to herein may refer to a single display 66 for ease of illustration, the principles discussed herein may also be applied to multiple displays 66, e.g., to view portions of UIs rendered by or with an application on separate side-by-side screens. That is, any reference to a display 66 may include any one or more displays 66 or screens providing similar visual functions. UI(s) may receive one or more inputs from one or more input devices 68, which may include or incorporate inputs made via the display 66 as well as any other available input to the computing environment 8 (e.g., via the I/O module 70), such as haptic or touch gestures, voice commands, eye tracking, biometrics, keyboard or button presses, etc. Such inputs may be applied by a user interacting with the computing environment 8, e.g., by operating the client device 24.

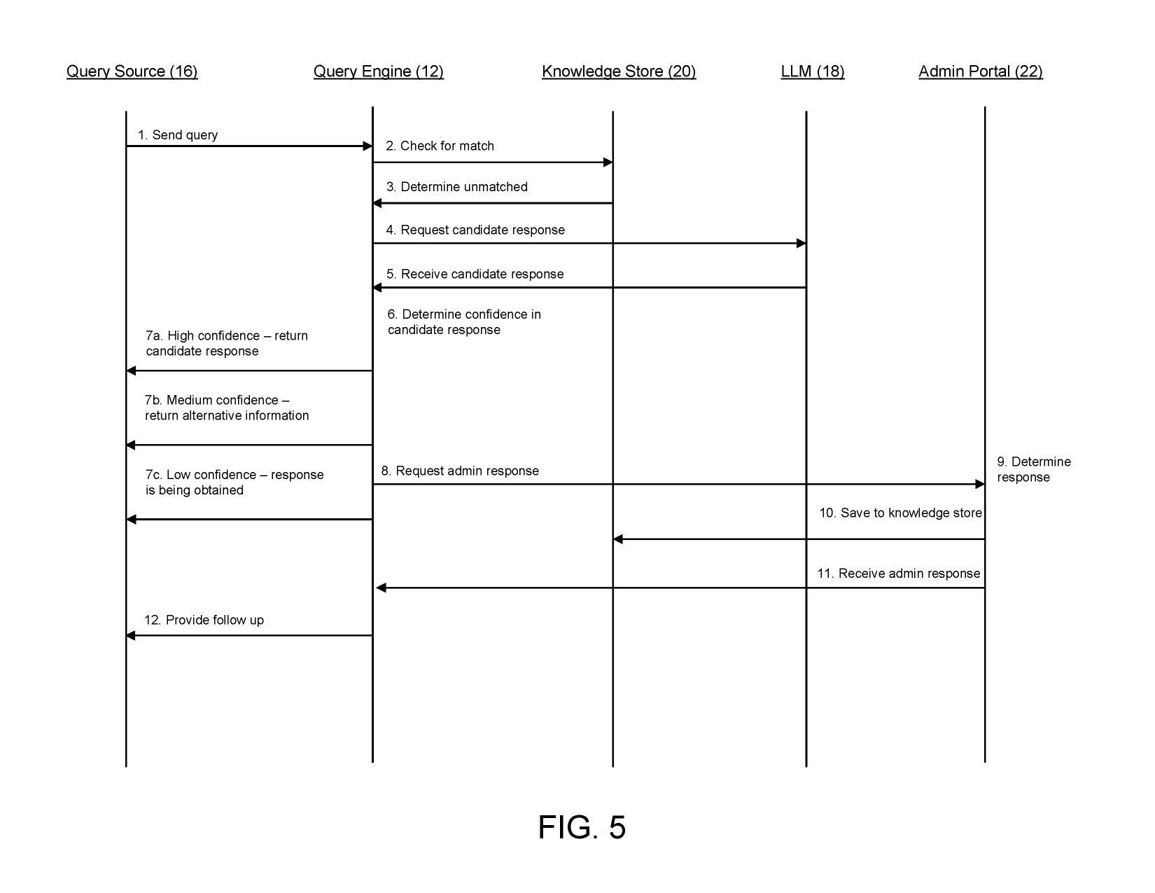

Referring now to FIG. 5, a sequence diagram is shown illustrating example operations that may be executed by the query engine 12 and other entities in the computing environment 8 for handling unmatched queries 50 according to confidence values, scores or levels/degrees of confidence. At step 1, the query source 16 provides a query 14 to the query engine 12. The query engine 12 checks for a match at step 2, by accessing the knowledge store 20 to determine if an existing QA pair is likely to provide a suitable response 15 to that query 14. Determining if an existing QA pair provides a suitable response 15 may be performed by comparing content in the query 14 to the QA pair, e.g., using a semantic analysis (e.g., LLM-based by prompting the LLM 18), vector similarity search, or using other comparison techniques such as tag matching, look-up tables, etc. For example, a query 14 related to when a store closes may be relevant to a QA pair that provides the complete store hours as the response 15. That is, a semantic analysis or tag related to store hours may enable the query engine 14 to determine a suitable match. In another example, by applying a semantic analysis, e.g., by generating an LLM prompt to be processed by the LLM 18, the query engine 12 may determine that the query 14 is seeking hours on a particular day of the week or a holiday, which may not be determinable from a QA pair that relates to normal hours or only weekday hours, etc. That is, the comparison of the query 14 and the knowledge store 20 may require various levels of analyses to determine if the query 14 is matched or unmatched.

At step 3, it is assumed for the sake of illustration that the query 14 sent at step 1 is unmatched. In this example, the query engine 12 (e.g., via the query evaluator 42) may use the confidence module 44 to evaluate a confidence that the query engine 12 has in a generated response 15 to the query 14 that cannot be matched to an existing entry in the knowledge store 20. In this example, the query engine 12 may prompt the LLM 18 at step 4, using content from the query 14, to request a candidate response to the query 14. For example, the LLM 18 may be prompted to find an answer to a question posed in the query 14.

At step 5, the query engine 12 receives a candidate response. At step 6, the query engine 12 may determine a confidence value or confidence score or other metric or parameter that may be used to determine whether the query engine 12 has confidence in the candidate response, and by how much or to what extent, relative to other queries 14. Depending on the confidence value or score determined by the confidence module 44, one or more different responses may be generated, such as the three different responses shown in steps 7a, 7b, and 7c in this illustrative example.

At step 7a, when there is a high level of confidence in the candidate response, e.g., where a confidence value is at or above an upper threshold value, the query engine 12 may use the candidate response as the response 15 returned to the query source 16.

When the confidence value is below the upper threshold value, or if there is only one threshold value that has been set, the query engine 12 may return an alternative to the candidate response. The alternative may include information with caveats associated with a lower level of confidence, may provide additional information or links to information to have the query source 16 perform a self-resolution, may indicate that an answer is not available at this time and/or that an answer is being sought, or that the query 14 cannot be processed, etc. In this example, upper and lower thresholds may be used to determine one of three different responses 15. The first response, shown in step 7a provides the candidate response given that the query engine 12 is confident in that response 15. Below, example alternative responses to the candidate response are shown for illustrative purposes.

At step 7b, the confidence level may not be considered “high” but may also not be considered “low”. If such a “medium” level of confidence is determined, e.g., where the confidence value is between an upper threshold value and a lower threshold value, alternative information may be returned. This alternative response may include, as noted above, the candidate response with a caveat associated with the confidence the query engine 12 has in the answer, links to information that was found but not considered definitive, or notifications to have the query source 16 expect a follow up if/when a verified response 15 can be found.

At step 7c, if the confidence level is considered low, e.g., is below a lower threshold value, the query engine 12 may indicate to the query source 16 that an answer is not available. If an answer is being sought, a notification may be provided or the query engine 12 may simply end the inquiry or request that the query source 16 provide a different or revised query 14.

Where the candidate response does not meet the upper (or only) threshold, the query engine 12 may communicate with the admin portal 22 at step 8, to request an administrator’s response. For example, the unmatched query 50 may be provided to the admin portal 22 with a request to obtain a response 15 to the unmatched query 50 or to have the candidate response verified or corrected. At step 9, the admin portal 22 may initiate or trigger a process at an administrative entity to determine the response 15. This process may additionally have the verified, corrected, or newly generated response 15 saved to the knowledge store 20 at step 10. For example, the query 14 may be related to a question that the administrative entity had not previously contemplated and for which a QA pair would benefit future inquires. As such, saving a new QA pair in the knowledge store 20 allows the system 10 to continually improve and expand the knowledge store 20 over time.

At step 11, the query engine 12 receives an admin response, which may be used at step 12 to follow up with the query source 16. For example, the query engine 12 may, at step 7b or step 7c, indicate that a response 15 is being determined and that the system 10 will follow up when an answer is obtained. The system 10 may therefore create an asynchronous response queue to generate and send follow-up responses 15 to unmatched queries 14. This may be integrated with a notification service used by the system 10 and/or an available communication channel, including the original communication channel used by the query source 16 to send the query 14 at step 1. This may include, for example, an email, push notification, SMS or other medium that is separate from the real-time conversational chat.

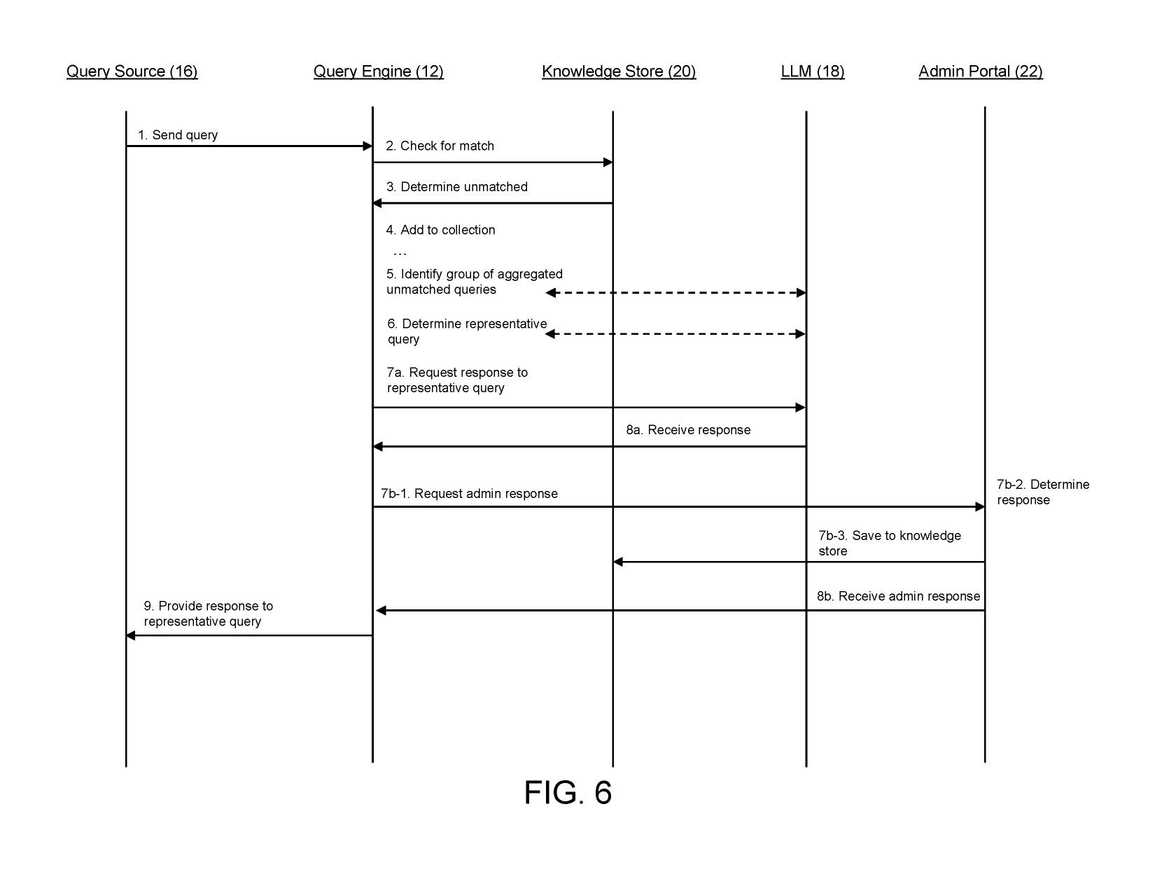

Referring now to FIG. 6, a sequence diagram is shown illustrating example operations that may be executed by the query engine 12 and other entities in the computing environment 8 in handling unmatched queries 50 by aggregating similar unmatched queries 50. At step 1, the query source 16 sends a query 14 to the query engine 12. The query engine 12 checks for a match at step 2, by accessing the knowledge store 20 to determine if an existing QA pair is likely to provide a suitable response 15 to that query 14, as discussed above in relation to FIG. 5.

At step 3, it is assumed for the sake of illustration that the query 14 sent at step 1 is unmatched. In this example, the query engine 12 (e.g., via the query evaluator 42) may use the unmatched module 48 to add the query 14 to the datastore of unmatched queries 50 for aggregating similar unmatched queries 50. The unmatched queries 50 may be grouped together using a static embeddings model or by using an LLM to identify similar content in the queries 14. In this example, the query engine 12 add the query 14 to a collection in the unmatched queries 50 at step 4. According to a metric such as a number of similar queries, a time window, etc., at step 5, the query engine 12 identifies a group of unmatched queries 50 to be aggregated. For example, queries 14 related to store opening hours, store closing hours, how long a store is opened, etc., may be aggregated into a new query 14 or it may be determined that one of these unmatched queries 50 is representative of the information being sought, e.g., weekly store hours.

At step 6, the query engine 12, e.g., via the unmatched module 48, may determine a representative query 14. In either or both steps 5 and 6, the aggregation of similar unmatched queries 50 and/or the determination of a representative query 14 may utilize the LLM 18. For example, a collection or group of similar queries 14 that have not been matched may be identified by having the LLM 18 sort or group the collection by prompting the LLM 18 with the candidates. Additionally, a group or set of queries 14 to be aggregated may differ enough from each other that a representative query 14 for that group or set is determined. This may be performed by selecting one of the queries 14 in the set or group, or by generating a new query 14 that is representative of the group or set, e.g., by providing the group or set to the LLM 18 to generate a proposed response 15.

The representative query 14 may be used to obtain a response at step 7. In this example, two alternative paths are shown, namely a first path including steps 7a/7b or a second path including steps 7b/8b. In step 7a, the LLM 18 is prompted with the representative query 14 to generate and return a response 15 at step 8a. In the alternative, at step 7b-1, the query engine 12 may request a response 15 from an administrator by communicating with the admin portal 22 to determine a response at step 7b-2. As discussed above, admin-generated responses may be considered verified or of high quality and may be saved to the knowledge store 20 at step 7b-3 to improve and expand the knowledge store 20. At step 8b, the admin response 15 may be returned to the query engine 12.

At step 9, the response 15 to the representative query 14 may be provided to the query source 16, whether the response 15 is obtained from the LLM 18, the admin portal 22 or some other entity.

It can be appreciated that the processes illustrated in FIGS. 5 and 6 may be combined. For example, the confidence-based responses shown in FIG. 5 may be utilized following receipt of a response to a representative query that is obtained using the LLM 18 or some entity other than the admin portion 22 which can provide verified answers to questions posed in a query 14. That is, following step 8a as shown in FIG. 6, steps 6 through 12 shown in FIG. 5 may be executed, including communicating with the admin portal 22 if necessary. Alternatively, the processes shown in FIGS. 5 and 6 may be executed separately and in parallel after determining that a query 14 is unmatched.

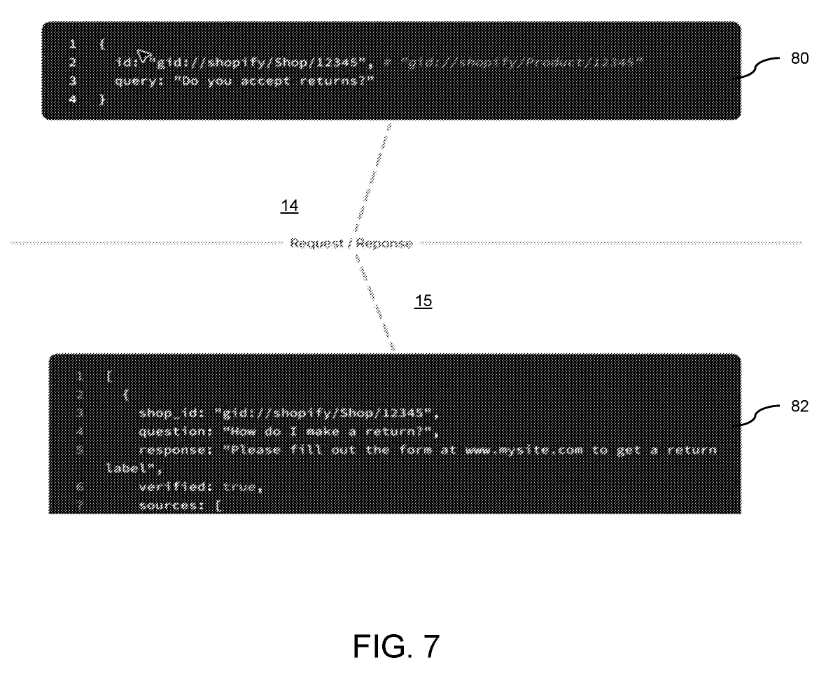

Referring now to FIG. 7, an example of an originating query 80 from a query source 16 is shown, which is mapped by the query engine 12 to a QA pair in the knowledge store 20. In this example, the originating query 80 includes the content: “Do you accept returns?”. This query 80 may be parsed to determine that a QA pair 82 exists in the knowledge store 20 related to the process for making a return. In this example, the question is “How do I make a return?”, and the answer is “Please fill out the form at www.mysite.com to get a return label”. In this scenario, the query engine 12, e.g., using the LLM 18, may determine that the originating query 80, although only seeking a yes/no answer, can be matched to the QA pair 82 where “yes” is implied and the answer additionally provides the method for executing a return. As such, the QA pair 82 may not include the exact wording of the originating query 80 but can be matched based on similarities or semantic analysis that can deduce a match. The matching of a candidate QA pair 82 (i.e. one that exists) to the content in a query 14 may additionally use the confidence mechanism illustrated in FIG. 5 or a variation in which the confidence scoring methodology is applied to determine if a match is “good enough” to return as the response 15.

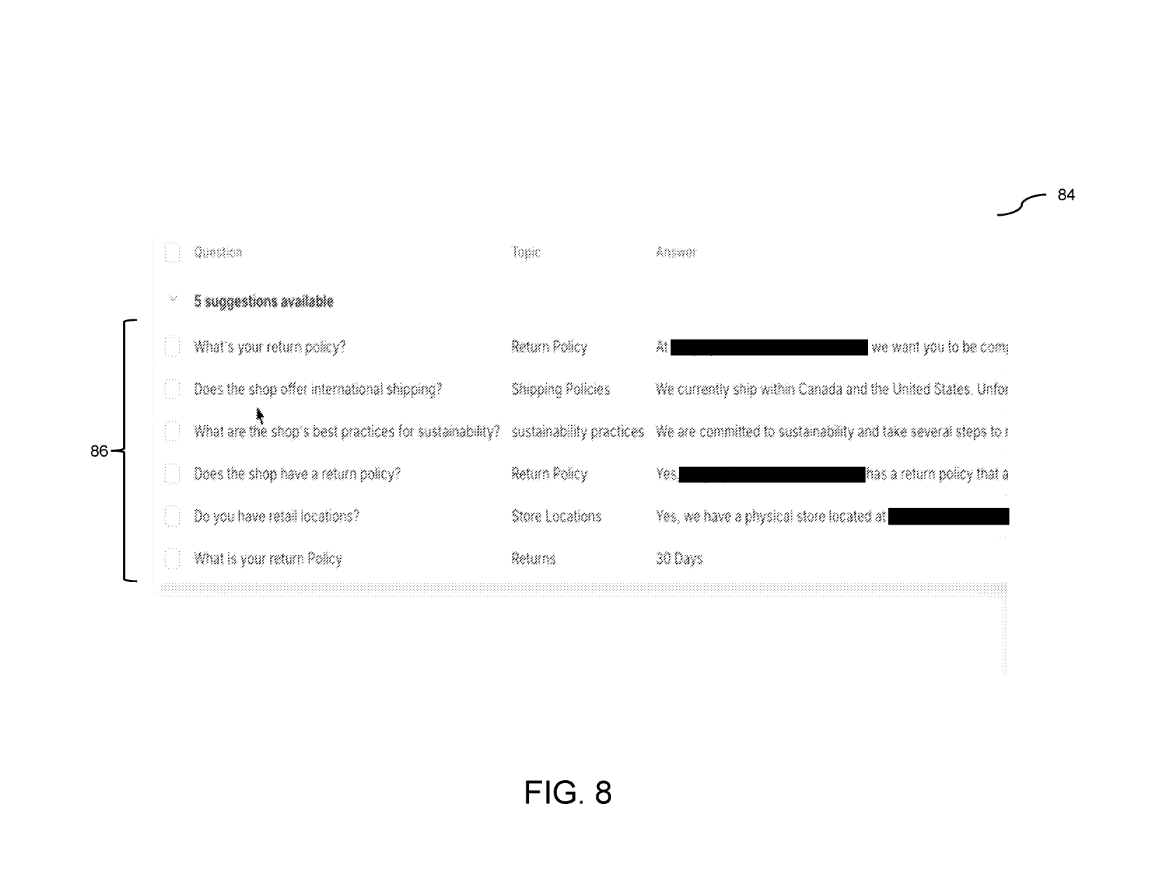

FIG. 8 illustrates a knowledge store UI 84. The knowledge store UI 84 may be used to view, edit, add or otherwise interact with the contents of the knowledge store 20. In this example, a number of QA pair entries 86 are shown in the UI 84. Each entry 86 includes a question, an answer and in this example a topic. The topic allows QA pairs to be grouped or organized. By selecting an entry 86, the user may be able to edit or view additional information. The knowledge store 20 includes a pool of QA pairs that may be customized by an administrator, e.g., using the UI 84. The administrator may have an asynchronous worker entity or monitoring process (e.g., worker thread or worker process) review the QA pair entries 86 to refine or verify answers and/or to adapt to new sources of information or changes to associated content. The QA pair entries 86 may therefore be tied to certain data sources such that updates can propagate back to the pool – e.g., changes to store hours, modified return policies, temporal campaigns or sales, etc.

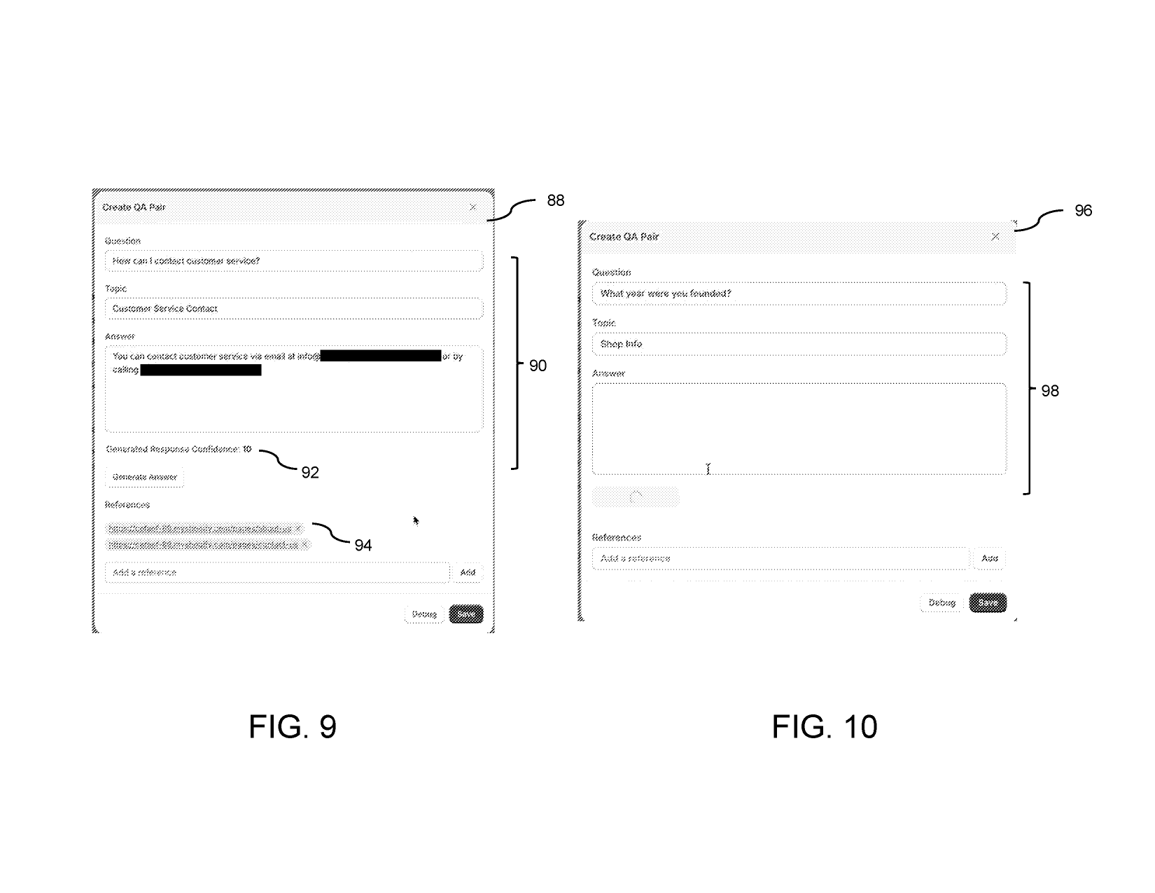

FIG. 9 illustrates a create QA pair form 88, which has been populated automatically, e.g., using the LLM 18. For example, the form 88 may be filled in to generate a candidate response to an unmatched query 50. The QA pair content 90 may be added by the LLM 18 or other entity used to search and obtain the potentially relevant content. As shown in FIG. 9, a confidence score 92 may be included. In this way, the form 88 may be provided to an administrator or other entity to determine if the content 90 is suitable (verifiable), can be improved (modifiable), or should be rejected (discardable). The form 88 may additionally include references 94 to provide sources from which the content 90 was obtained. The references 94 may, additionally or alternatively, be provided in a response 15, e.g., at step 7b shown in FIG. 5 as discussed earlier.

FIG. 10 illustrates a partially completed form 96 to illustrate that the forms 88, 96 may be used to generate new QA pairs at any time. For example, the admin portal 22 may be used to pre-load the knowledge store 20 for a particular entity and/or may be used to create new QA pairs in response to unsuccessful candidate responses or to verify candidate responses, e.g., as shown in FIGS. 5 and 6.

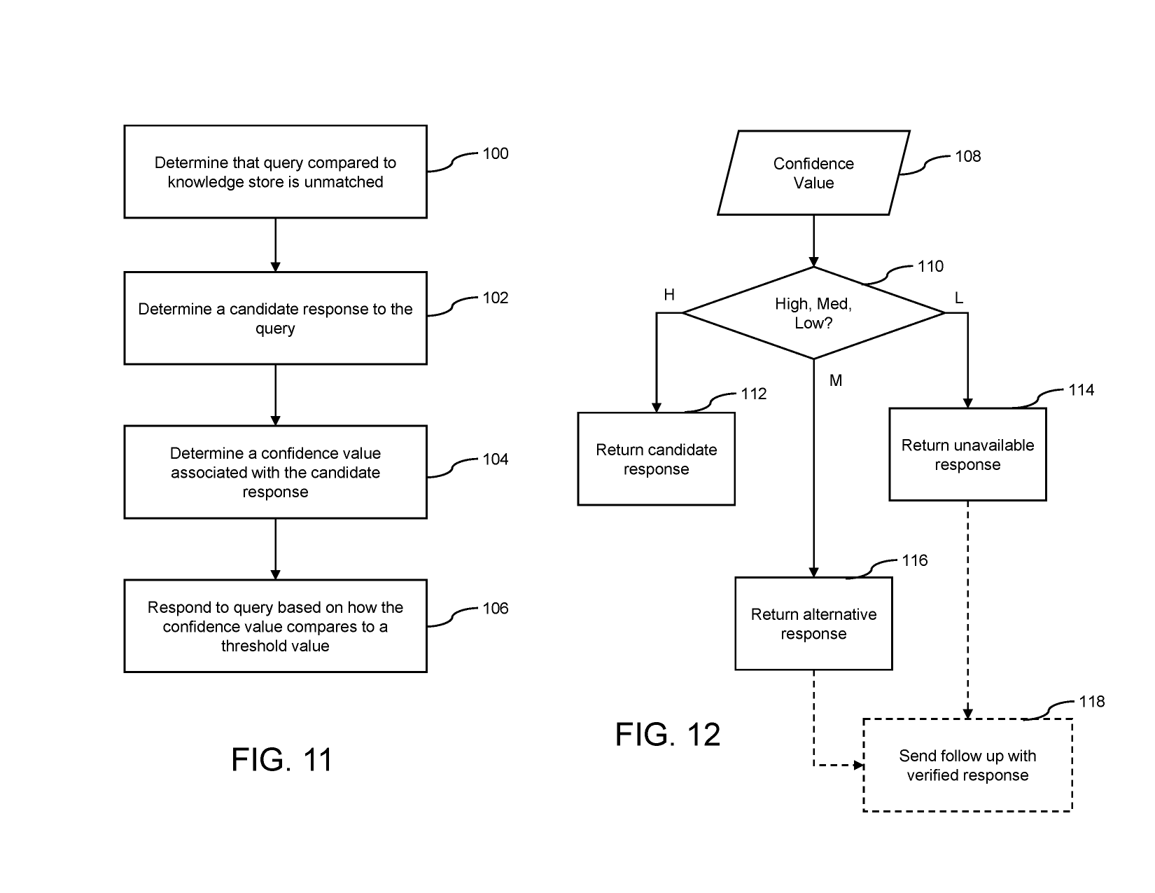

Referring now to FIG. 11, a flow chart is provided illustrating example operations for query response management based on a confidence value. The operations shown in FIG. 11 may be implemented by an electronic device (e.g., client device 26), a server (e.g., query server 24), or other computing system, computing service, or other computing entity in the computing environment 8.

At block 100, the query engine 12 determines that a query 14, which has or is being compared to the contents of the knowledge store 20 is unmatched. At block 102, the query engine 12 determines a candidate response 15 to the query 14. For example, automated searches may be conducted using search engines or other sources, the LLM 18 may be prompted, etc. At block 104, the query engine 12 may use the confidence module 44 to determine a confidence value associated with the candidate response 15. As discussed above, the confidence value may be determined using any suitable confidence measurement methodology and may include one or more thresholds to which to compare the determined confidence value. At block 106, the query engine 12 responds to the query 14 based on how the confidence value compares to a threshold value, e.g., as shown in FIG. 5.

FIG. 12 provides a flow chart illustrating example operations for responding to a query 14 based on confidence values. The confidence value 108 may be evaluated at block 110 according to high, medium, and low ranges of confidence, based on a determined set of thresholds, for example whether the confidence value 108 is above a first (upper) threshold, below a second (lower) threshold, or between the first and second thresholds. Similar to what is illustrated in FIG. 5, when a high level of confidence exists, the candidate response determined at block 102 in FIG. 11 is returned to the query source 16 at block 112.

At block 114, when a response 15 is not available or the candidate response 15 is not usable, an unavailable response 15 may be returned. This may be associated with a low confidence or the confidence value being at or below the second (lower) threshold.

At block 116, for confidence values 108 between the thresholds, an alternative response such as reference material, optional answers, or other information may be returned in a response 15.

Optionally, as shown in dashed lines, at block 118, a follow up may be sent with a verified response 15, e.g., if the candidate response 15 is verified by an administrator or if the query 14 is otherwise processed and answered at some later time.

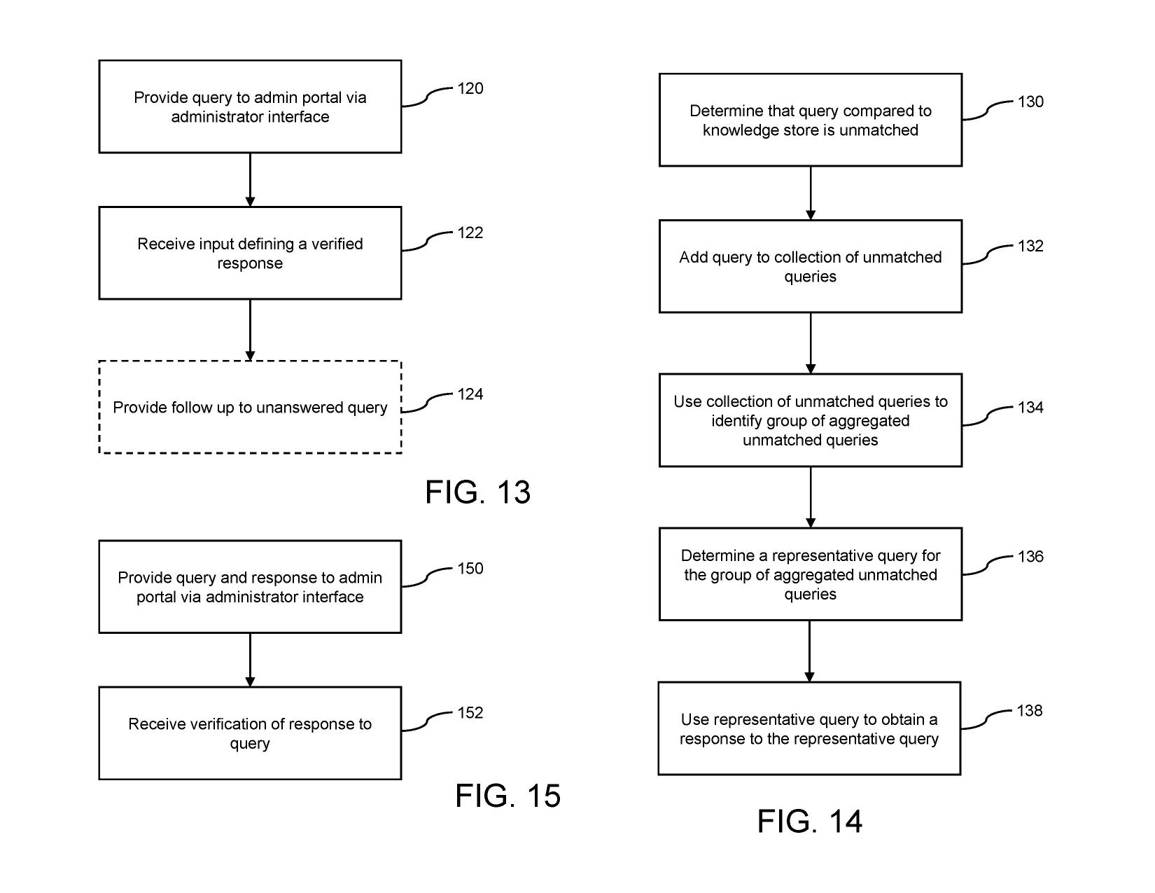

The follow up may be obtained, for example, as shown in FIG. 13. At block 120, the query 14 may be provided to the admin portal 22, e.g., via the admin interface 52. The query engine 12 may then receive an input from the admin portal 22 defining a verified response 15. That is, the query engine 12 may obtain a reply from a verification request or inquiry provided via the admin interface 52. Optionally, at block 124, a follow up to the unanswered query may be provided to the query source 16.

Referring now to FIG. 14, a flow chart is provided illustrating example operations for query response management by collecting and aggregating unmatched queries 50. At block 130, the query engine 12 determines that a query 14 that has been compared to the contents of the knowledge store 20 is unmatched. At block 132, the query 14 that is unmatched is added to the collection or data store of unmatched queries 50.

At block 134, the collection of unmatched queries 50 is used to identify a group of aggregated unmatched queries 50. At block 136, a representative query 14 is determined for the group of aggregated unmatched queries 50, e.g., by selecting one from the group or generating a new representative query 14. At block 138, the representative query 14 is used to obtain a response 15 to the representative query 14, e.g., as shown in FIG. 6.

FIG. 15 is a flow chart that illustrates example operations that may be performed in verifying a new QA pair associated a query 14, such as an unmatched query 50, including, for example, a representative query 14 and response 15. At block 150, the new query 14 and the answer that was automatically obtained (e.g., using LLM 18) are provided to the admin portal 22 via the admin interface 52. At block 152, a verification of the response 15 to the query 14, which may be used to add new QA pairs to the knowledge store 20, to follow up to unmatched queries 50, etc.

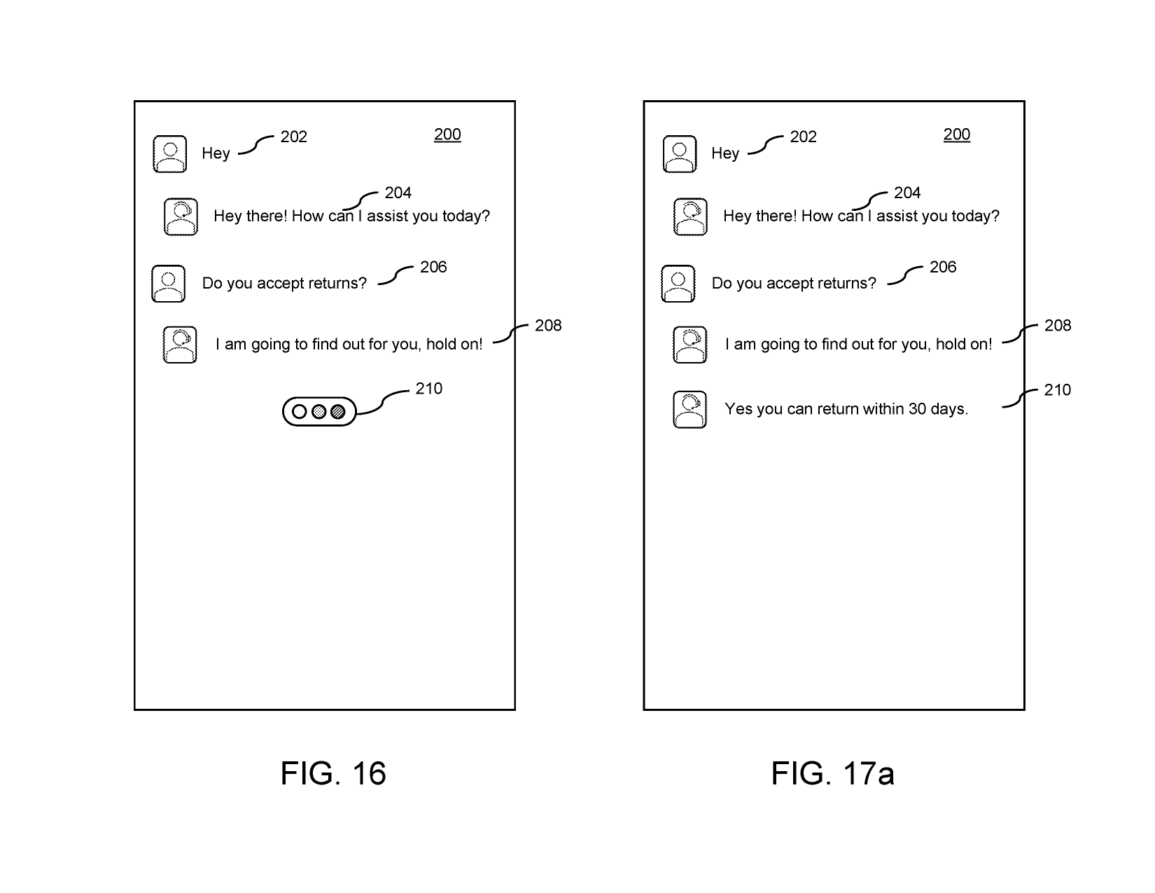

Referring now to FIG. 16, a messaging conversation UI 200 is shown, e.g., for conducting a conversation with an LLM-powered chatbot 34. A first message 202 from a user and a reply 204 from the chatbot invite the user to ask a question or provide information that can be used to generate a query 14. In this example, a second message 206 from the user asks: “Do you accept returns?”. In response, the chatbot 34 provides a second reply 208, which in this example indicates that a response to the second message 206 is being obtained. Optionally, as shown in FIG. 16, a waiting animation 210 may be used to signal to the user that progress is being made by the chatbot 34.

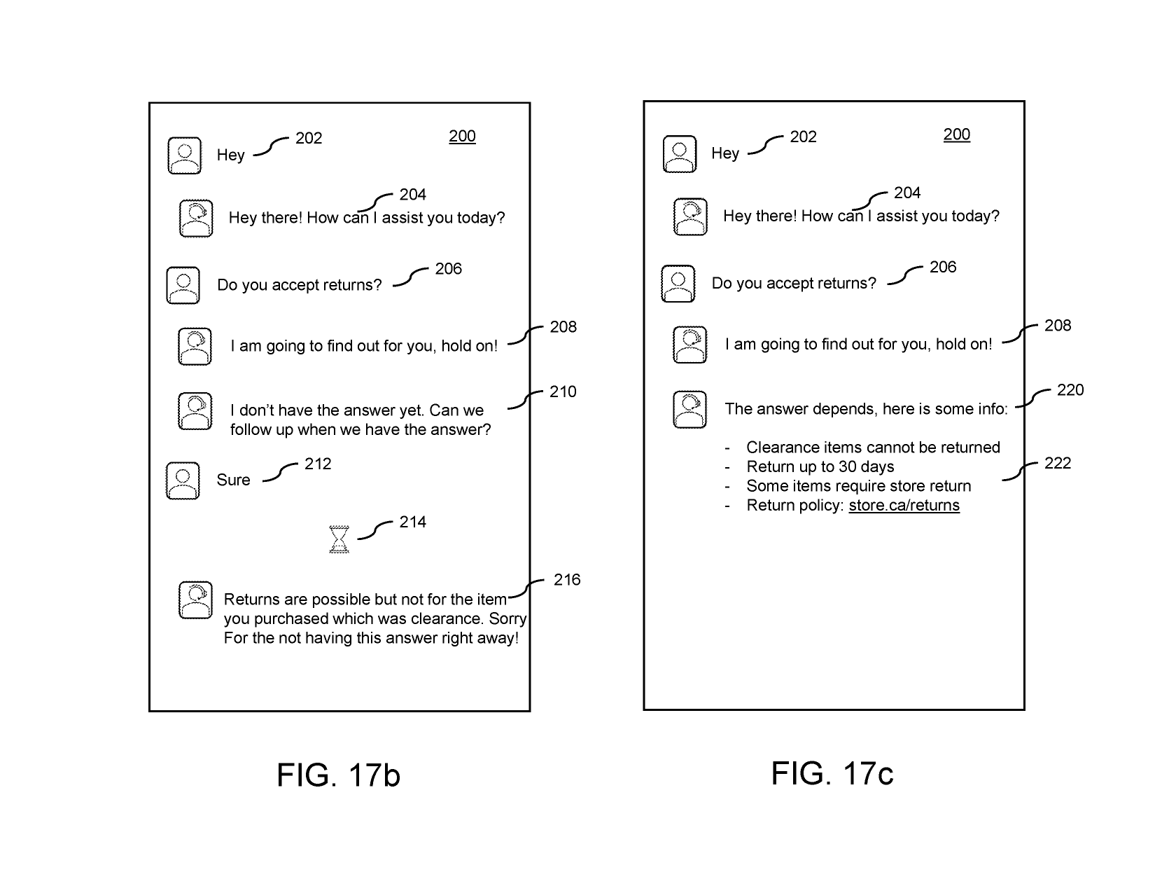

FIGS. 17a, 17b, and 17c illustrate different example answers to the second message 206. In FIG. 17a, an answer 210 is provided promptly or immediately. This may illustrate a matched QA pair answer or a candidate response 15 that has a relatively high level of confidence associated therewith.

Referring to FIG. 17b, an example of a follow up using a verified response 15 is shown. In this example, the chatbot 34 provides the following intermediate reply 210: “I don’t have the answer yet. Can we follow up when we have the answer?”. The user in this example provides a third message 212 indicating that they agree to receive the follow up. Time may pass as illustrated using an hourglass icon 214, after which a verified response 216 is provided, with additional details concerning a specific type of purchase and how the return policy applies.

Referring to FIG. 17c, an example of an alternative response 220 is shown. This response 220 may be provided when the information obtained by the query engine 12 has a medium level of confidence, e.g., between upper and lower confidence thresholds. In this case, the chatbot indicates that the answer depends, and provides additional information, which may include one or more links to allow the user to make a self-determination or to explore further. While not shown in FIG. 17c, additional features may be included, such as an option to seek a verified response or to revise and resubmit a new query 14.

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

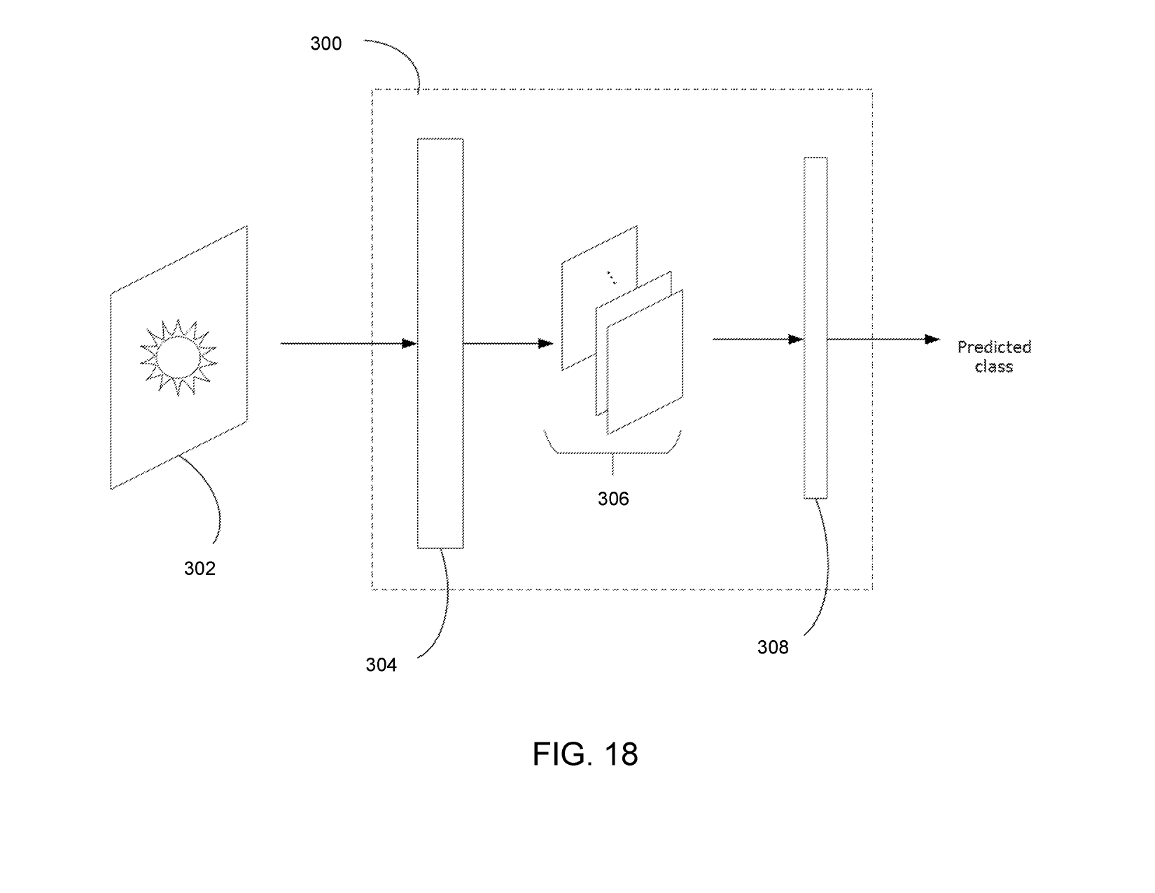

FIG. 18 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs 18.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM 18 may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

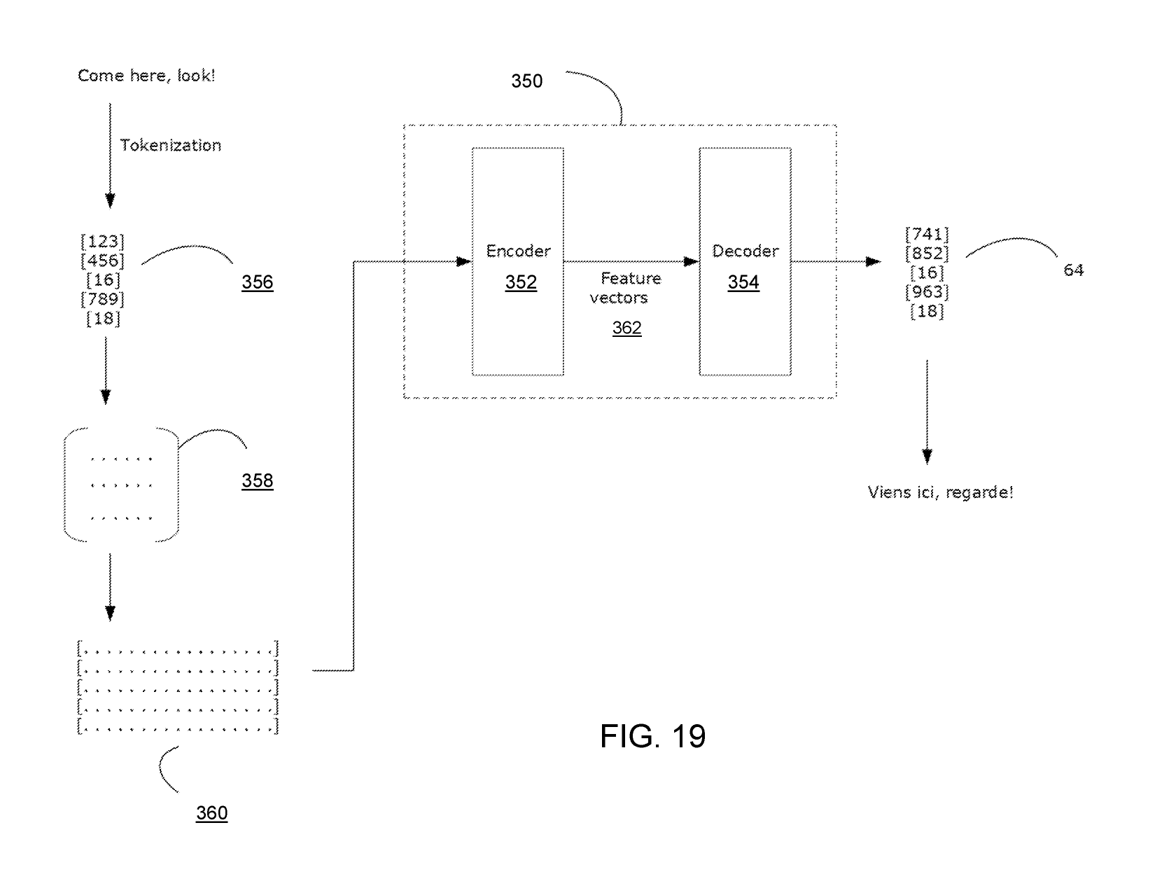

FIG. 19 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs 18 may be trained on a large unlabelled corpus. Some LLMs 18 may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 19, a short sequence of tokens 356 corresponding to the text sequence “Come here, look!” is illustrated as input to the transformer 350. Tokenization of the text sequence into the tokens 356 may be performed by some preprocessing tokenization module such as, for example, a byte pair encoding tokenizer (the “pre” referring to the tokenization occurring prior to the processing of the tokenized input by the LLM 18), which is not shown in FIG. 19 for simplicity. In general, the token sequence that is inputted to the transformer 350 may be of any length up to a maximum length defined based on the dimensions of the transformer 350 (e.g., such a limit may be 2048 tokens in some LLMs 18). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 18. An example GPT-type LLM 18 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 18, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 18 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 18 may be referred to as a prompt, which is a natural language input that includes instructions to the LLM 18 to generate a desired output. A computing system may generate a prompt that is provided as input to the LLM 18 via its API. As described above, the prompt may optionally be processed or preprocessed into a token sequence prior to being provided as input to the LLM 18 via its API. A prompt can include one or more examples of the desired output, which provides the LLM 18 with additional information to enable the LLM 18 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 8, any entity within the computing environment 8 such as the system 10 and/or computing devices 24, 26; any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

What is claimed is:

1. A computer-implemented method comprising:
determining that a query compared to a knowledge store of query and response pairs is unmatched;
adding the query to a collection of unmatched queries;
using the collection of unmatched queries to identify a group of aggregated unmatched queries;
determining a representative query for the group of aggregated unmatched queries; and
using the representative query to obtain a response to the representative query.

2. The method of claim 1, further comprising using the response to the representative query to generate a new query and response pair for the knowledge store.

3. The method of claim 2, comprising:
providing the new query and response pair to an administrator portal; and
receiving a verification of the response to the representative query.

4. The method of claim 1, further comprising providing the response to the representative query to a source of the query.

5. The method of claim 1, wherein the group of aggregated unmatched queries is determined based on a number of unmatched queries added to the collection.

6. The method of claims claim 1, wherein the group of aggregated unmatched queries is determined based on a time window relative to receipt of the query that is determined to be unmatched.

7. The method of claim 1, wherein the aggregated unmatched queries are grouped using an LLM.

8. The method of claim 1, wherein the aggregated unmatched queries are grouped using a static embeddings model.

9. The method of claim 1, wherein the representative query is determined by selecting a query from the group of aggregated unmatched queries.

10. The method of claim 1, wherein the representative query is determined by generating a new query based on the group of aggregated unmatched queries.

11. The method of claim 10, wherein the new query is generated using an LLM.

12. The method of claim 1, wherein the query is compared to the knowledge store using an LLM-based semantic analysis.

13. The method of claim 1, wherein the query is compared to the knowledge store using a vector similarity search.

14. The method of claim 1, wherein the query is obtained from an LLM-powered chatbot.

15. The method of claim 1, further comprising providing the query and/or the response to an administrator interface to have a new query and response pair generated for the knowledge store.

16. A computer system comprising:
a processor; and
a memory, the memory storing processor executable instructions that, when executed by the processor, cause the computer system to:
determine that a query compared to a knowledge store of query and response pairs is unmatched;
add the query to a collection of unmatched queries;
use the collection of unmatched queries to identify a group of aggregated unmatched queries;
determine a representative query for the group of aggregated unmatched queries; and
use the representative query to obtain a response to the representative query.

17. The system of claim 16, further comprising processor executable instructions that, when executed by the processor, cause the computer system to use the response to the representative query to generate a new query and response pair for the knowledge store.

18. The system of claim 17, comprising processor executable instructions that, when executed by the processor, cause the computer system to:
provide the new query and response pair to an administrator portal; and
receive a verification of the response to the representative query.

19. The system of claim 16, further comprising processor executable instructions that, when executed by the processor, cause the computer system to provide the response to the representative query to a source of the query.

20. A computer-readable medium storing processor executable instructions that, when executed by a processor of a computer system, cause the computer system to:
determine that a query compared to a knowledge store of query and response pairs is unmatched;
add the query to a collection of unmatched queries;
use the collection of unmatched queries to identify a group of aggregated unmatched queries;
determine a representative query for the group of aggregated unmatched queries; and
use the representative query to obtain a response to the representative query.
